(19) United States
(12) Patent Application Publication
(10) Pub. No.: US 2025/0178071 A1
(43) Pub. Date: Jun. 5, 2025

(54) PROPELLER SHAFT MANUFACTURING METHOD AND PROPELLER SHAFT

(71) Applicant: HITACHI ASTEMO, LTD., Hitachinaka-shi, Ibaraki (JP)

(72) Inventors: Hidekazu AOKI, Hitachinaka-shi, Ibaraki (JP); Daiki TSUTSUMI, Hitachinaka-shi, Ibaraki (JP); Yasushi AKITA, Hitachinaka-shi, Ibaraki (JP); Kenichiro ISHIKURA, Hitachinaka-shi, Ibaraki (JP)

(73) Assignee: HITACHI ASTEMO, LTD., Hitachinaka-shi, Ibaraki (JP)

(21) Appl. No.: 18/836,306

(22) PCT Filed: Feb. 15, 2023
(86) PCT No.: PCT/JP2023/005196

§ 371 Date: Aug. 6, 2024

(30) Foreign Application Priority Data
Mar. 14, 2022 (JP) 2022-038854

(51) Int. Cl. B21K 1/10; B23K 20/12; B23K 26/282; B23K 103/10; F16C 3/02

(52) U.S. Cl. CPC B21K 1/10; B23K 26/282; F16C 3/023; B23K 20/122; B23K 2103/10

(57) ABSTRACT

In a propeller shaft (PS1) according to the present invention, a thickness (Tw) of a welding portion (13) formed by welding a first tubular member (11) and a second tubular member (12) is formed to be thinner than a thickness (T1) of a first end portion of a first tubular portion (111) and also thinner than a thickness (T1) of a first end portion of a second tubular portion (121). Therefore, the thickness (Tw) of the welding portion (13) is reduced, and weight of the welding portion (13) can be reduced. With this, it is possible to suppress runout of the welding portion (13) and imbalance in rotation of the propeller shaft (PS1) during rotation of the propeller shaft (PS1).

### TECHNICAL FIELD

The present invention relates to a method of manufacturing a propeller shaft and the propeller shaft.

### BACKGROUND ART

As a conventional manufacturing method of a propeller shaft, a manufacturing method disclosed in, for instance, the following Patent Document 1 has been known.

To put it briefly, the manufacturing method of the propeller shaft disclosed in this Patent Document has a first step of forming a first tubular member formed by a first tubular portion and a first joint portion which are seamlessly integrated with each other, a second step of forming a second tubular member formed by a second tubular portion and a second joint portion which are seamlessly integrated with each other, and a third step of joining the first tubular member and the second tubular member by friction stir welding.

### CITATION LIST

### Patent Document

Patent Document 1: Japanese Unexamined Patent Application Publication No. JP2003-322135

### SUMMARY OF THE INVENTION

### Technical Problem

In the conventional manufacturing method of the propeller shaft, however, the first tubular member and the second tubular member are joined by friction stir welding. Because of this, a thickness of a welding portion between the first tubular member and the second tubular member is formed to be thicker than an end portion on the first joint portion side of the first tubular member and an end portion on the second joint portion side of the second tubular member. As a consequence, weight of the welding portion between the first tubular member and the second tubular member increases. Therefore, there is room for improvement in that runout (or run-out) of the welding portion increases during rotation of the propeller shaft and in that there is a risk of causing imbalance in rotation of the propeller shaft.

The present invention was made in view of the above technical problem of the conventional manufacturing method of the propeller shaft. An object of the present invention is therefore to provide a method of manufacturing the propeller shaft and the propeller shaft which are capable of reducing the thickness of the welding portion between the first tubular member and the second tubular member.

### Solution to Problem

According to one aspect of the present invention, the thickness of the welding portion between the first tubular member and the second tubular member is formed to be thinner than a thickness of an end portion (a first end portion) on the first joint portion side of the first tubular member and also thinner than a thickness of an end portion (a first end portion) on the second joint portion side of the second tubular member.

### Effects of Invention

According to the present invention, it is possible to reduce the thickness of the connecting portion (the welding portion) between the first tubular member and the second tubular member.

### BRIEF DESCRIPTION OF THE DRAWINGS

FIG. 1 is a cross section of a propeller shaft which is cut along an axial direction of the propeller shaft, according to a first embodiment of the present invention.

FIG. 2 is a cross section of a tubular member shown in FIG. 1.

FIG. 3A to 3C are enlarged views of a first joint portion shown in FIG. 1. FIG. 3A is a perspective view. FIG. 3B is a drawing viewed from an A-direction of FIG. 3A.

FIG. 3C is a drawing viewed from a B-direction of FIG. 3A.

FIGS. 4A to 4E are drawings showing a manufacturing method of the propeller shaft according to a first embodiment of the present invention.

FIG. 5 is a cross section of a tubular member which is cut along an axial direction of the tubular member, according to a first modified example of the first embodiment of the present invention.

FIG. 6 is a cross section of a tubular member which is cut along an axial direction of the tubular member, according to a second modified example of the first embodiment of the present invention.

FIG. 7 illustrates a second embodiment of the present invention. FIG. 7 is a cross section of a tubular member of the propeller shaft which is cut along an axial direction of the propeller shaft, according to the second embodiment.

FIG. 8 is a cross section of a tubular member which is cut along an axial direction of the tubular member, according to a first modified example of the second embodiment of the present invention.

FIG. 9 is a cross section of a tubular member which is cut along an axial direction of the tubular member, according to a second modified example of the second embodiment of the present invention.

FIG. 10 illustrates a third embodiment of the present invention. FIG. 10 is a cross section of a tubular member of the propeller shaft which is cut along an axial direction of the propeller shaft, according to the third embodiment.

FIG. 11 is a cross section of a tubular member which is cut along an axial direction of the tubular member, according to a first modified example of the third embodiment of the present invention.

FIG. 12 is a cross section of a tubular member which is cut along an axial direction of the tubular member, according to a second modified example of the third embodiment of the present invention.

### EMBODIMENTS FOR CARRYING OUT THE INVENTION

Embodiments of a propeller shaft and a method of manufacturing the propeller shaft according to the present invention will be described below with reference to the drawings. In the following embodiments, examples in which the propeller shaft is applied as a propeller shaft for a vehicle, as in the conventional case, will be described.

Further, in the following description, for the sake of convenience, a left side in each drawing is referred to as a “front”, and a right side is referred to as a “rear”. Further, a direction along a rotation axis Z of the propeller shaft in each drawing is referred to as an “axial direction”, a direction orthogonal to the rotation axis Z is referred to as a “radial direction”, and a direction of rotation about the rotation axis Z is referred to as a “circumferential direction”.

### First Embodiment

### (Configuration of Propeller Shaft)

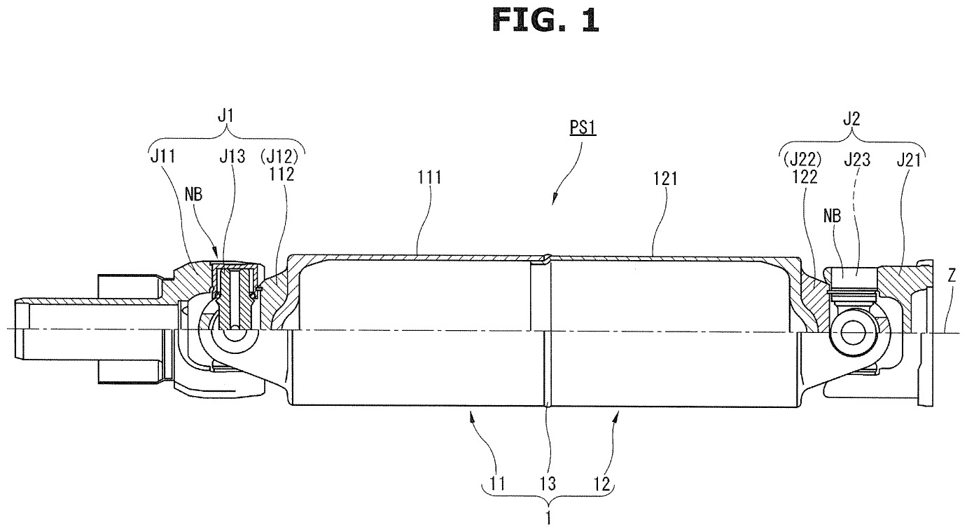

FIG. 1 is a cross section of a propeller shaft PS1 according to a first embodiment of the present invention, which is cut along an axial direction of the propeller shaft PS1, and illustrates an overall shape of the propeller shaft PS1.

As illustrated in FIG. 1, the propeller shaft PS1 is disposed along a longitudinal direction of a vehicle between a first rotation shaft (not shown) that is a rotation shaft located at a front side of the vehicle and a second rotation shaft (not shown) that is a rotation shaft located at a rear side of the vehicle. For instance, in a vehicle whose drive system is an FR (front engine and rear drive) drive system, the first rotation shaft corresponds to an output shaft of a transmission which is arranged at the front side of the vehicle and to which a rotation force is transmitted from a drive source such as an engine and a motor. The second rotation shaft corresponds to an input shaft of a differential gear which is arranged at the rear side of the vehicle and which transmits the rotation force to rear wheels of the vehicle.

That is, the propeller shaft PS1 is configured by a substantially cylindrical tubular shaft body 1 which corresponds to a tubular member of the present invention. This shaft body 1 is connected to the transmission (not shown) through a first joint member J1, and is connected to the differential gear (not shown) through a second joint member J2. The shaft body 1 is configured as a single-piece member by connecting a first tubular member 11 forming a front half portion of the shaft body 1 and a second tubular member 12 forming a rear half portion of the shaft body 1, which are tubular members divided into two in the axial direction, through a welding portion 13.

The first joint member J1 has a first drive-side joint member J11 connected to the output shaft (not shown) of the transmission (not shown) through a spline (not shown) so as to be able to rotate integrally with the output shaft of the transmission, an after-described first joint portion 112 formed integrally with a front end portion of the first tubular member 11 of the shaft body 1 and forming a first driven-side joint member J12, and a first cruciform shaft J13 connecting the first drive-side joint member J11 and the first joint portion 112 so as to be able to integrally rotate. Here, a substantially cylindrical tubular dust cover DC is attached to an outer circumferential side of a base end portion of the first drive-side joint member J11 so as to overlap a case (not shown) of the transmission (not shown) in a radial direction. Entry of foreign matter from the outside is therefore suppressed by this dust cover DC.

The second joint member J2 has an after-described second joint portion 122 formed integrally with the second tubular member 12 of the shaft body 1 and forming a second drive-side joint member J22, a second driven-side joint member J21 connected to the input shaft (not shown) of the differential gear (not shown) through a connecting member (e.g. a screw) (not shown) so as to be able to rotate integrally with the input shaft of the differential gear, and a second cruciform shaft J23 connecting the second joint portion 122 and the second driven-side joint member J21 so as to be able to integrally rotate.

### (Configuration of Shaft Body)

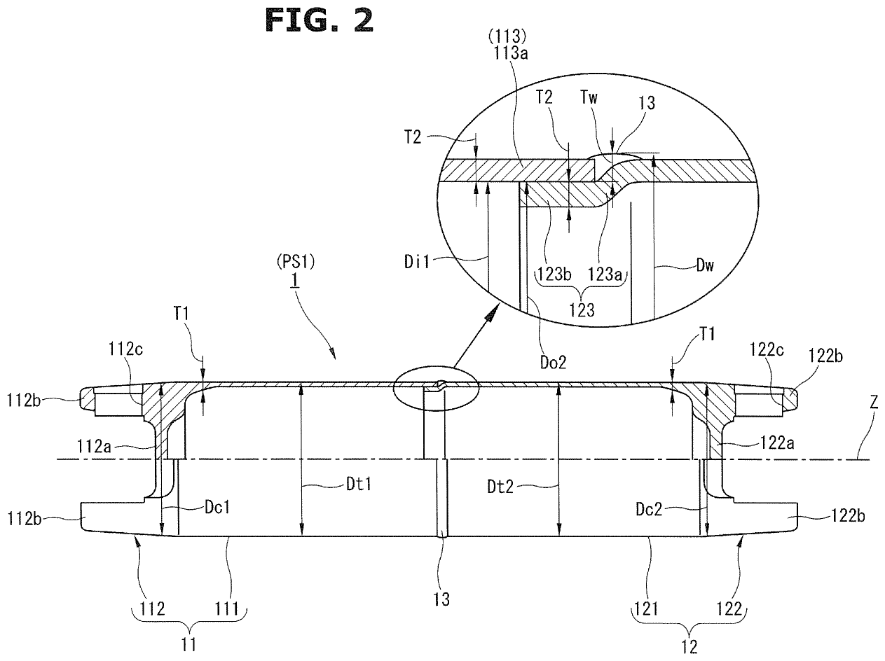

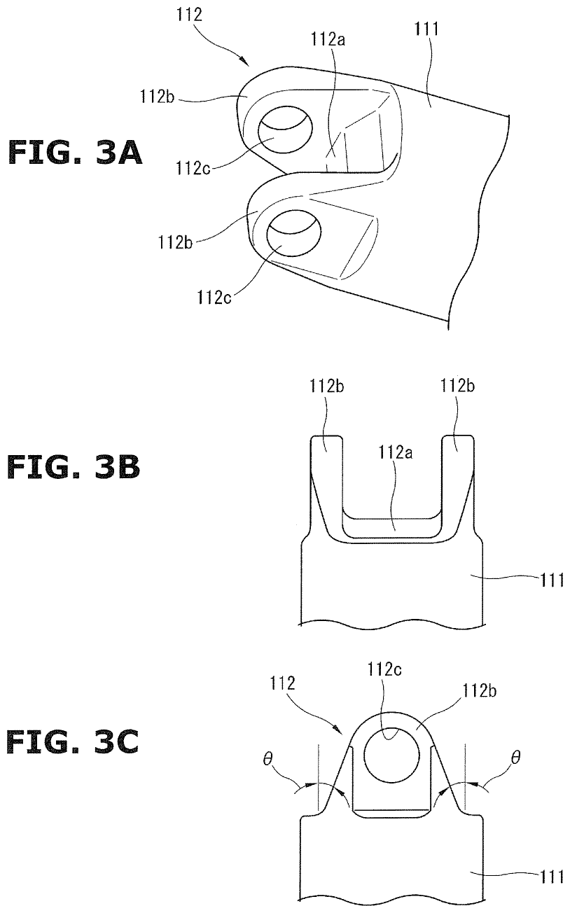

FIG. 2 illustrates a cross section of the shaft body 1, as the tubular member shown in FIG. 1, cut along an axial direction of the shaft body 1. FIG. 3A to 3C are enlarged views of an essential part of the first joint portion 112 shown in FIG. 2.

As illustrated in FIG. 2, the shaft body 1 has the first tubular member 11 forming the front half portion of the shaft body 1, the second tubular member 12 forming the rear half portion of the shaft body 1 and the welding portion 13 formed by welding a rear end portion of the first tubular member 11 and a front end portion of the second tubular member 12 along a circumferential direction, and these first tubular member 11, second tubular member 12 and welding portion 13 are integrally formed.

The first tubular member 11 has a first tubular portion 111 formed into a cylindrical tubular shape and the first joint portion 112 formed at a front end portion of the first tubular portion 111 and connecting to the first drive-side joint member J11, and these first tubular portion 111 and first joint portion 112 are integrally formed. Here, the first tubular member 11 is formed by plastically deforming metal material (e.g. aluminium). In the present embodiment, the first tubular member 11 is molded by well-known impact extrusion of cold forging that is one of the plastic deformation.

The first tubular portion 111 has a cylindrical tubular shape having an almost constant outside diameter in the axial direction. A first end portion of the first tubular portion 111, where the first joint portion 112 is provided, is closed by the first joint portion 112, whereas a second end portion of the first tubular portion 111, located on an opposite side to the first end portion in the axial direction, is open to the outside as a first opening end portion 113. Further, the first tubular portion 111 is formed so that a thickness T1 of the first end portion is gradually thicker toward the first joint portion 112 side and a thickness T2 of the second end portion is formed to be a substantially constant thickness that is thinner than the thickness T1 of the first end portion.

As illustrated in FIGS. 2 and 3A to 3C, the first joint portion 112 has a first joint base portion 112a closing the first end portion of the first tubular portion 111 and bifurcated first joint yoke portions 112b, 112b extending substantially parallel to each other from an outer side surface of the first joint base portion 112a along the axial direction and facing each other with respect to the rotation axis Z, and these first joint base portion 112a and first joint yoke portions 112b, 112b are integrally formed.

The first joint base portion 112a is formed so that its middle portion located between the pair of first joint yoke portions 112b, 112b protrudes toward an axial direction outer side (in a direction in which the first joint yoke portions 112b, 112b extend) with respect to an outer peripheral edge of the first joint base portion 112a, and extends in the radial direction so as to connect the first joint yoke portions 112b, 112b.

Each of the first joint yoke portions 112b, 112b has, at inner and outer sides thereof, side surfaces that are substantially parallel to each other, and the first joint yoke portions 112b, 112b are arranged so as to be slightly offset inwards with respect to the outer peripheral edge of the first joint base portion 112a. The first joint yoke portions 112b, 112b have a pair of first joint bearing holes 112c, 112c formed for bearings of the first cruciform shaft J13 so as to penetrate the first joint yoke portions 112b, 112b and face each other with respect to the rotation axis Z. The first joint bearing holes 112c, 112c rotatably support a pair of shaft portions J131, J131 of the first cruciform shaft J13 through needle bearings NB.

The first joint yoke portions 112b, 112b are formed so that an outside diameter Dc1 of the first joint yoke portions 112b, 112b is substantially equal to an outside diameter Dt1 of the first tubular portion 111. It is noted that as long as the outside diameter Dc1 of the first joint yoke portions 112b, 112b is equal to or less than the outside diameter Dt1 of the first tubular portion 111, the outside diameter Dc1 of the first joint yoke portions 112b, 112b can be arbitrarily set according to specifications of the first joint member J1.

Further, the first joint yoke portions 112b, 112b are each formed so as to have a relatively large draft angle θd and also so that a curvature of each of corner round portions 112d, 112d at both root portion sides thereof is as large as possible. With this, relatively good flow of the metal material (aluminium in the present embodiment) during the forging (the impact extrusion) molding can be obtained, and the forging molding of the first joint yoke portions 112b, 112b can be relatively facilitated.

As illustrated in FIG. 2, the second tubular member 12 has a second tubular portion 121 formed into a cylindrical tubular shape and the second joint portion 122 formed at a rear end portion of the second tubular portion 121 and connecting to the second driven-side joint member J21, and these second tubular portion 121 and second joint portion 122 are integrally formed. Here, in the same manner as the first tubular member 11, the second tubular member 12 is formed by plastically deforming metal material (e.g. aluminium). In the present embodiment, the second tubular member 12 is molded by well-known impact extrusion of cold forging that is one of the plastic deformation.

The second tubular portion 121 has a cylindrical tubular shape having an almost constant outside diameter in the axial direction. A first end portion of the second tubular portion 121, where the second joint portion 122 is provided, is closed by the second joint portion 122, whereas a second end portion of the second tubular portion 121, located on an opposite side to the first end portion in the axial direction, is open to the outside as a second opening end portion 123. Further, the second tubular portion 121 is formed so that a thickness T1 of the first end portion is gradually thicker toward the second joint portion 122 side and a thickness T2 of the second end portion is formed to be a substantially constant thickness that is thinner than the thickness T1 of the first end portion.

Here, regarding the second opening end portion 123, a diameter of the second end portion of the second tubular portion 121 reduces stepwise so that an outside diameter Do2 of the second end portion of the second tubular portion 121 is equal to an inside diameter Di1 of the second end portion of the first tubular portion 111, then the second opening end portion 123 can be fitted into an inner side of the first opening end portion 113. More specifically, the second opening end portion 123 has an inner step portion 123a that is bent or curved stepwise inwards in the radial direction and a reduced diameter portion 123b that is reduced in diameter from the inner step portion 123a and extends along the axial direction. Then, the second opening end portion 123 is connected to the first opening end portion 113 with the inner step portion 123a facing the first opening end portion 113 in the axial direction and with the reduced diameter portion 123b fitted into an inner circumferential side of the first opening end portion 113. In other words, in a relationship with the second opening end portion 123, the first opening end portion 113 forms an enclosing portion 113a that covers an outer circumferential side of the reduced diameter portion 123b of the second opening end portion 123.

The second joint portion 122 has a second joint base portion 122a closing the first end portion of the second tubular portion 121 and bifurcated second joint yoke portions 122b, 122b extending substantially parallel to each other from an outer side surface of the second joint base portion 122a along the axial direction and facing each other with respect to the rotation axis Z, and these second joint base portion 122a and second joint yoke portions 122b, 122b are integrally formed. Further, the second joint portion 122 is provided so that a phase in a rotation direction of the second joint yoke portions 122b, 122b coincides with a phase in a rotation direction of the first joint yoke portions 112b, 112b of the first joint portion 112. Since a shape of each part of the second joint portion 122 is the same as that of the first joint portion 112, specific structures or configurations are referred to the description of the structure or configuration of the first joint portion 112, and their detailed description will be omitted.

As described above, the second tubular member 12 has the same shape as that of the first tubular member 11 except for the second opening end portion 123. In other words, the second tubular member 12 is a member formed by adding the inner step portion 123a and the reduced diameter portion 123b to the first opening end portion 113 of the first tubular member 11.

The welding portion 13 is a portion formed by laser-welding the first opening end portion 113 of the first tubular member 11 and the second opening end portion 123 of the second tubular member 12. The welding portion 13 is formed throughout the entire circumference of the tubular member along the circumferential direction while straddling the first opening end portion 113 of the first tubular portion 111 and the inner step portion 123a of the second tubular portion 121. That is, this welding portion 13 is formed so as to bulge in a padded manner (or in a build-up manner) between the first opening end portion 113 of the first tubular portion 111 and the inner step portion 123a of the second tubular portion 121. In other words, the welding portion 13 has a substantially arc-shaped cross section that bulges outwards in the radial direction, and has a diameter Dw that is larger than the diameter Dt1 of the first tubular portion 111, the diameter Dc1 of the first joint portion 112, a diameter Dt2 of the second tubular portion 121 and a diameter Dc2 of the second joint portion 122. Further, a thickness Tw of the welding portion 13 is formed so as to be thinner than the thickness T1 of the first end portion of the first tubular portion 111 and also thinner than the thickness T1 of the first end portion of the second tubular portion 121.

### (Manufacturing Method of Propeller Shaft)

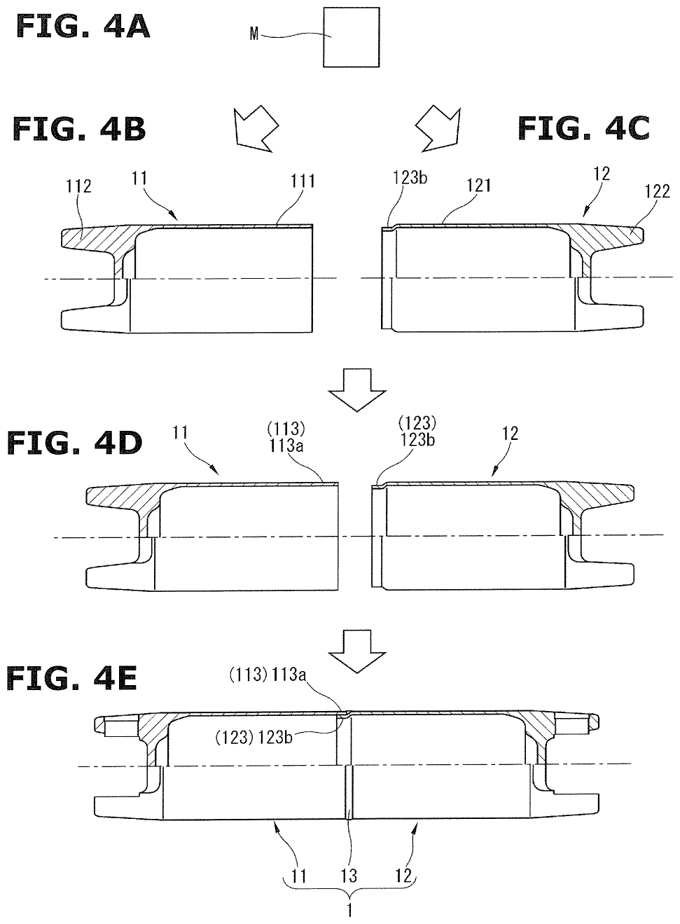

FIGS. 4A to 4E illustrate a manufacturing method of the shaft body 1 shown in FIG. 2. FIG. 4A is a drawing of a side surface of material M. FIG. 4B illustrates a step of manufacturing the first tubular member 11. FIG. 4C illustrates a step of manufacturing the second tubular member 12. FIG. 4D illustrates a step of press-fitting the second tubular member 12 into the first tubular member 11. FIG. 4E illustrates a step of welding a connecting portion between the first tubular member 11 and the second tubular member 12.

To manufacture the shaft body 1, first, the material M made of aluminium shown in FIG. 4A is set in a mold (not shown). Then, as illustrated in FIG. 4B, by the impact extrusion method, by extruding the first joint portion 112 forward and extending or stretching the first tubular portion 111 rearward, the first tubular portion 111 and the first joint portion 112 are simultaneously molded, then the first tubular member 11 is formed (a first step according to the present invention).

Likewise, the material M made of aluminium shown in FIG. 4A is set in a mold (not shown). Then, as illustrated in FIG. 4C, by the impact extrusion method, by extruding the second joint portion 122 forward and extending or stretching the second tubular portion 121 rearward, the second tubular portion 121 and the second joint portion 122 are simultaneously molded, then the second tubular member 12 is formed (a second step according to the present invention).

Subsequently, as illustrated in FIG. 4D, the reduced diameter portion 123b of the second opening end portion 123 of the second tubular member 12 is press-fitted into the inner circumferential side of the first opening end portion 113 of the first tubular member 11 until the inner step portion 123a of the second opening end portion 123 of the second tubular member 12 comes into contact with an end edge of the first opening end portion 113.

Finally, as illustrated in FIG. 4E, a portion (or a space) between the first opening end portion 113 of the first tubular member 11 and the inner step portion 123a of the second tubular member 12 is welded by laser-welding (a third step according to the present invention), and the welding portion 13 is formed between the first opening end portion 113 of the first tubular member 11 and the inner step portion 123a of the second tubular member 12, then the manufacture of the shaft body 1 is completed.

### Working and Effect of the Present Embodiment

In the conventional manufacturing method of the propeller shaft, the first tubular member and the second tubular member are joined by friction stir welding. Because of this, a thickness of a welding portion between the first tubular member and the second tubular member is formed to be thicker than an end portion on the first joint portion side of the first tubular member and an end portion on the second joint portion side of the second tubular member. In particular, in the case of the friction stir welding, the welding is performed by pressing, from an outer circumferential side, a tool against a butted end portion which becomes a connecting portion between the first tubular member and the second tubular member. For this reason, in order to act as a backing plate that can resist a pressing force of the tool, the conventional method adopts a configuration in which one of the first tubular member and the second tubular member is formed to be thicker than the other and overlaps an inner circumferential side of the other (see FIG. 1 of Patent Document 1). As a consequence, weight of the welding portion between the first tubular member and the second tubular member increases. Therefore, there is room for improvement in that runout (or run-out) of the welding portion increases during rotation of the propeller shaft and in that there is a risk of causing imbalance in rotation of the propeller shaft.

In contrast to this, in the case of the propeller shaft PS1 and the manufacturing method of the propeller shaft PS1 according to the present embodiment, the following effects can be brought about, then the above technical problem of the conventional manufacturing method of the propeller shaft can be solved.

The manufacturing method of the propeller shaft PS1 according to the present embodiment, which is the manufacturing method of the propeller shaft transmitting a driving force of the vehicle, has the first step of forming, by plastic working of the metal material, the first tubular member 11 having the first tubular portion 111 and the first joint portion 112 seamlessly integrated with the first tubular portion 111 at the first end portion in the direction of the rotation axis Z of the first tubular portion 111; the second step of forming, by plastic working of the metal material, the second tubular member 12 having the second tubular portion 121 and the second joint portion 122 seamlessly integrated with the second tubular portion 121 at the first end portion in the direction of the rotation axis Z of the second tubular portion 121; and the third step of forming, by welding the first opening end portion 113 formed at the second end portion located on the opposite side to the first end portion of the first tubular portion 111 and the second opening end portion 123 formed at the second end portion located on the opposite side to the first end portion of the second tubular portion 121, the welding portion 13 whose thickness Tw is thinner than the thickness T1 of the first end portion of the first tubular portion 111 and also thinner than the thickness T1 of the first end portion of the second tubular portion 121.

In other words, the propeller shaft PS1 according to the present embodiment, which is the propeller shaft transmitting a driving force of the vehicle, has the tubular member (the shaft body 1) formed by connecting the first tubular portion 111 and the second tubular portion 121; the first joint portion 112 provided at the first end portion in the direction of the rotation axis Z of the first tubular portion 111 and seamlessly integrated with the first tubular portion 111; the second joint portion 122 provided at the first end portion in the direction of the rotation axis Z of the second tubular portion 121 and seamlessly integrated with the second tubular portion 121; and the welding portion 13 formed by welding the first opening end portion 113 provided at the second end portion located on the opposite side to the first end portion of the first tubular portion 111 and the second opening end portion 123 provided at the second end portion located on the opposite side to the first end portion of the second tubular portion 121 and having the thickness Tw that is thinner than the thickness T1 of the first end portion of the first tubular portion 111 and also thinner than the thickness T1 of the first end portion of the second tubular portion 121.

As described above, according to the present embodiment, the thickness Tw of the welding portion 13 formed by welding the first tubular member 11 and the second tubular member 12 is formed to be thinner than the thickness T1 of the first end portion of the first tubular portion 111 and also thinner than the thickness T1 of the first end portion of the second tubular portion 121. Therefore, the thickness Tw of the welding portion 13 is reduced, and weight of the welding portion 13 can be reduced. With this, it is possible to suppress the runout (or run-out) of the welding portion 13 and the imbalance in rotation of the propeller shaft PS1 during rotation of the propeller shaft PS1.

Further, in the manufacturing method of the propeller shaft PS1 according to the present embodiment, the plastic workings at the first step and the second step are performed by impact extrusion.

In other words, at least one of a set of the first tubular portion 111 and the first joint portion 112 and a set of the second tubular portion 121 and the second joint portion 122 (both sets in the present embodiment) of the propeller shaft PS1 according to the present embodiment is formed by the impact extrusion.

As described above, according to the present embodiment, by forming the first tubular member 11 and the second tubular member 12 by the impact extrusion method, the first tubular portion 111 and the first joint portion 112, or the second tubular portion 121 and the second joint portion 122, can be formed at the same step. It is therefore possible to reduce man-hour (the number of steps) for forming the first tubular member 11 and the second tubular member 12, and reduce machine and equipment for forming the first tubular member 11 and the second tubular member 12, thereby lowering manufacturing cost of the propeller shaft PS1.

In addition, according to the impact extrusion method, because there is no need to form the first opening end portion 113 and the second opening end portion 123 to be thick, each thickness of the first tubular portion 111 and the second tubular portion 121 can be formed thinner, which can contribute to reducing the weight of the propeller shaft PS1.

Further, in the manufacturing method of the propeller shaft PS1 according to the present embodiment, each of the first joint portion 112 and the second joint portion 122 is formed into the bifurcated yoke shape.

As described above, in the present embodiment, since each of the first joint portion 112 and the second joint portion 122 is formed into the bifurcated yoke shape, versatility of the first joint portion 112 and the second joint portion 122 can be improved. Therefore, the propeller shaft PS1 can be applied to, for instance, also a vehicle such as a truck which requires maintenance of the first joint portion 112 and the second joint portion 122 due to, for instance, aged deterioration.

Further, in the manufacturing method of the propeller shaft PS1 according to the present embodiment, a phase in a rotation direction of the bifurcated yoke (the first joint yoke portions 112b, 112b) of the first joint portion 112 and a phase in a rotation direction of the bifurcated yoke (the second joint yoke portions 122b, 122b) of the second joint portion 122 coincide with each other.

As described above, in the present embodiment, since the phase in the rotation direction of the first joint yoke portions 112b, 112b of the first joint portion 112 and the phase in the rotation direction of the second joint yoke portions 122b, 122b of the second joint portion 122 coincide with each other, rotation fluctuation between the first joint portion 112 and the second joint portion 122 can be cancelled. It is therefore possible to improve rotation balance of the propeller shaft PS1.

Further, in the manufacturing method of the propeller shaft PS1 according to the present embodiment, the welding portion 13 is formed by laser-welding.

As described above, in the present embodiment, the welding portion 13 is formed by laser-welding. Therefore, a range or an area in the propeller shaft PS1 which is influenced by heat of the welding portion 13 can be suppressed to the minimum, thereby suppressing reduction in strength more effectively which is caused by the welding.

In addition, in the case of the laser-welding, because weld bead formed at the welding portion 13 can be suppressed to be smaller, increase in weight of the welding portion 13 can also be suppressed to the minimum. It is thus possible to suppress the runout (or run-out) and the imbalance in rotation of the propeller shaft PS1 effectively during rotation of the propeller shaft PS1.

Further, in the manufacturing method of the propeller shaft PS1 according to the present embodiment, at the second step, between the second joint portion 122 and the second opening end portion 123 of the second tubular member 12, the reduced diameter portion 123b that is reduced stepwise in diameter from the second joint portion 122 toward the second opening end portion 123 is formed. Further, at the third step, the laser-welding is performed with the reduced diameter portion 123b being fitted into the inner circumferential side of the first opening end portion 113.

In other words, in the propeller shaft PS1 according to the present embodiment, the second tubular portion 121 has, between the welding portion 13 and the second opening end portion 123, the reduced diameter portion 123b that is reduced stepwise in diameter from the welding portion 13 toward the second opening end portion 123. Also, the first tubular portion 111 has, between the first joint portion 112 and the first opening end portion 113, the enclosing portion 113a that covers the outer circumferential side of the reduced diameter portion 123b.

As described above, according to the present embodiment, since the laser-welding is performed with the reduced diameter portion 123b of the second tubular member 12 being fitted into the inner circumferential side of the first opening end portion 113 (the enclosing portion 113a) of the first tubular member 11, misalignment between the first tubular member 11 and the second tubular member 12 during the welding can be suppressed. The imbalance in rotation of the propeller shaft PS1 can therefore be suppressed.

Further, in the propeller shaft PS1 according to the present embodiment, the tubular member (the shaft body 1) is made of metal material containing aluminium.

As described above, in the present embodiment, since the shaft body 1 is made of metal material containing aluminium, as compared with a case where the shaft body 1 is made of e.g. iron whose specific gravity is higher than that of the aluminium, weight of the propeller shaft PS1 can be reduced.

In addition, because aluminium is readily formable (i.e. aluminium has good moldability) as compared with iron, molding tools or equipment can be reduced in size, and life of the mold can be improved, thereby contributing to lowering manufacturing cost of the propeller shaft PS1.

### First Modified Example

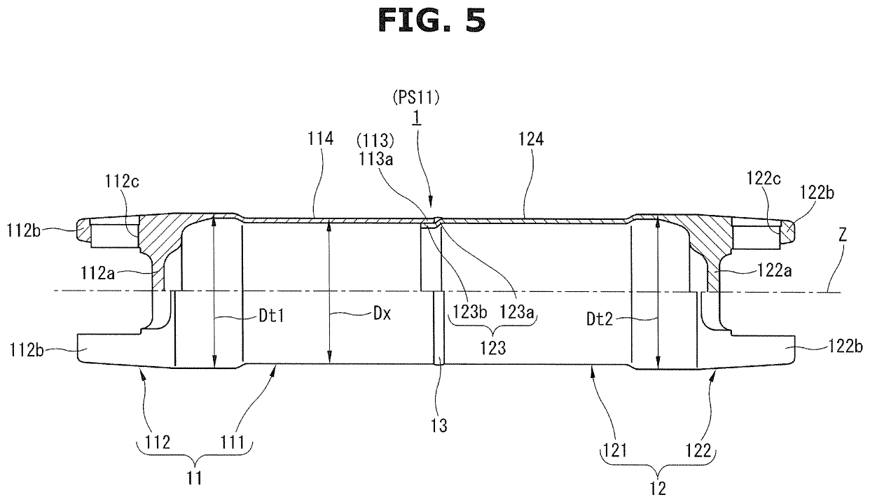

FIG. 5 is a first modified example of the first embodiment of the propeller shaft according to the present invention, and illustrates a modified configuration of the shaft body 1 of the first embodiment. Since a basic configuration except modified points is the same as that of the first embodiment, the same structure or configuration as that of the first embodiment is denoted by the same reference sign, and its detailed description is omitted here.

FIG. 5 is a cross section of a propeller shaft PS11 according to the first modified example of the first embodiment of the present invention, illustrated by cutting the shaft body 1 along an axial direction of the propeller shaft PS11.

As illustrated in FIG. 5, the propeller shaft PS11 according to the present modified example is formed so that a middle portion in the axial direction of the shaft body 1 is reduced in diameter and an outside diameter Dx of the middle portion in the axial direction of the shaft body 1 is smaller than outside diameters Dt1 and Dt2 of both end portions (a first end portion of the first tubular portion 111 and a first end portion of the second tubular portion 121) in the axial direction of the shaft body 1. In other words, the propeller shaft PS11 is the same as that of the first embodiment, except that the axial direction middle portion of the shaft body 1 is reduced in diameter.

More specifically, the propeller shaft PS11 has, between the first joint portion 112 and the first opening end portion 113 of the first tubular member 11, a first reduced diameter portion 114 whose outside diameter is reduced stepwise from the first joint portion 112 toward the first opening end portion 113. Likewise, the propeller shaft PS11 also has, between the second joint portion 122 and the second opening end portion 123 of the second tubular member 12, a second reduced diameter portion 124 whose outside diameter is reduced stepwise from the second joint portion 122 toward the second opening end portion 123. Then, an inner step portion 123a and a reduced diameter portion 123b that are further reduced stepwise in diameter in the radially inward direction are formed at the second opening end portion 123 of the second reduced diameter portion 124.

In this manner, the propeller shaft PS11 according to the present modified example is formed by laser-welding a portion (or a space) between an end edge of the first opening end portion 113 and the inner step portion 123a of the second opening end portion 123 along the circumferential direction with the reduced diameter portion 123b provided at the second opening end portion 123 of the second reduced diameter portion 124 being press-fitted into an inner circumferential side of the first opening end portion 113 of the first reduced diameter portion 114.

As described above, in the manufacturing method of the propeller shaft PS11 according to the present modified example, at the first step, between the first joint portion 112 and the first opening end portion 113 of the first tubular member 11, the first reduced diameter portion 114 whose outside diameter is reduced from the first joint portion 112 toward the first opening end portion 113 is formed. Further, at the second step, between the second joint portion 122 and the second opening end portion 123 of the second tubular member 12, the second reduced diameter portion 124 whose outside diameter is reduced from the second joint portion 122 toward the second opening end portion 123 is formed. Then, at the third step, the first reduced diameter portion 114 and the second reduced diameter portion 124 are welded.

In other words, in the propeller shaft PS11 according to the present modified example, the first tubular portion 111 has, between the first joint portion 112 and the first opening end portion 113, the first reduced diameter portion 114 whose outside diameter is reduced from the first joint portion 112 toward the first opening end portion 113. Further, the second tubular portion 121 has, between the second joint portion 122 and the second opening end portion 123, the second reduced diameter portion 124 whose outside diameter is reduced from the second joint portion 122 toward the second opening end portion 123. Then, as the welding portion 13, the first reduced diameter portion 114 and the second reduced diameter portion 124 are welded.

As described above, according to the present modified example, since the axial direction middle portion of the shaft body 1 is formed into the reduced diameter shape by the first reduced diameter portion 114 and the second reduced diameter portion 124, increase in weight of the shaft body 1 can be suppressed, thereby reducing weight of the propeller shaft PS11.

Further, since the axial direction middle portion of the shaft body 1 is formed into the reduced diameter shape by the first reduced diameter portion 114 and the second reduced diameter portion 124, it becomes possible to lay out the propeller shaft PS11 even in a vehicle having a narrow mounting space, thereby having the merit of improving layout property of the propeller shaft PS11.

### Second Modified Example

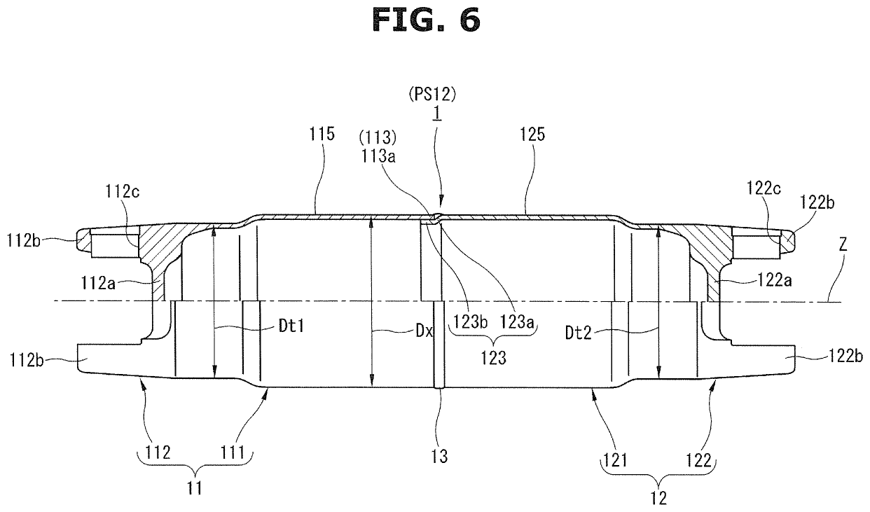

FIG. 6 is a second modified example of the first embodiment of the propeller shaft according to the present invention, and illustrates a modified configuration of the shaft body 1 of the first embodiment. Since a basic configuration except modified points is the same as that of the first embodiment, the same structure or configuration as that of the first embodiment is denoted by the same reference sign, and its detailed description is omitted here.

FIG. 6 is a cross section of a propeller shaft PS12 according to the second modified example of the first embodiment of the present invention, illustrated by cutting the shaft body 1 along an axial direction of the propeller shaft PS12.

As illustrated in FIG. 6, the propeller shaft PS12 according to the present modified example is formed so that a middle portion in the axial direction of the shaft body 1 is widened in diameter and an outside diameter Dx of the middle portion in the axial direction of the shaft body 1 is larger than outside diameters Dt1 and Dt2 of both end portions (a first end portion of the first tubular portion 111 and a first end portion of the second tubular portion 121) in the axial direction of the shaft body 1. In other words, the propeller shaft PS12 is the same as that of the first embodiment, except that the axial direction middle portion of the shaft body 1 is widened in diameter.

More specifically, the propeller shaft PS12 has, between the first joint portion 112 and the first opening end portion 113 of the first tubular member 11, a first widened diameter portion 115 whose outside diameter is widened stepwise from the first joint portion 112 toward the first opening end portion 113. Likewise, the propeller shaft PS12 also has, between the second joint portion 122 and the second opening end portion 123 of the second tubular member 12, a second widened diameter portion 125 whose outside diameter is widened stepwise from the second joint portion 122 toward the second opening end portion 123. Then, an inner step portion 123a and a reduced diameter portion 123b that are reduced stepwise in diameter in the radially inward direction are formed at the second opening end portion 123 of the second widened diameter portion 125.

In this manner, the propeller shaft PS12 according to the present modified example is formed by laser-welding a portion (or a space) between an end edge of the first opening end portion 113 and the inner step portion 123a of the second opening end portion 123 along the circumferential direction with the reduced diameter portion 123b provided at the second opening end portion 123 of the second widened diameter portion 125 being press-fitted into an inner circumferential side of the first opening end portion 113 of the first widened diameter portion 115.

As described above, in the manufacturing method of the propeller shaft PS12 according to the present modified example, at the first step, between the first joint portion 112 and the first opening end portion 113 of the first tubular member 11, the first widened diameter portion 115 whose outside diameter is widened from the first joint portion 112 toward the first opening end portion 113 is formed. Further, at the second step, between the second joint portion 122 and the second opening end portion 123 of the second tubular member 12, the second widened diameter portion 125 whose outside diameter is widened from the second joint portion 122 toward the second opening end portion 123 is formed. Then, at the third step, the first widened diameter portion 115 and the second widened diameter portion 125 are welded.

In other words, in the propeller shaft PS12 according to the present modified example, the first tubular portion 111 has, between the first joint portion 112 and the first opening end portion 113, the first widened diameter portion 115 whose outside diameter is widened from the first joint portion 112 toward the first opening end portion 113. Further, the second tubular portion 121 has, between the second joint portion 122 and the second opening end portion 123, the second widened diameter portion 125 whose outside diameter is widened from the . . . second joint portion 122 toward the second opening end portion 123. Then, as the welding portion 13, the first widened diameter portion 115 and the second widened diameter portion 125 are welded.

As described above, according to the present modified example, since the axial direction middle portion of the shaft body 1 is formed into the widened diameter shape by the first widened diameter portion 115 and the second widened diameter portion 125, strength of the propeller shaft PS12 can be increased.

Further, since the axial direction middle portion of the shaft body 1 is formed into the widened diameter shape by the first widened diameter portion 115 and the second widened diameter portion 125, it is possible to improve a bending characteristic value of the propeller shaft PS12.

### Second Embodiment

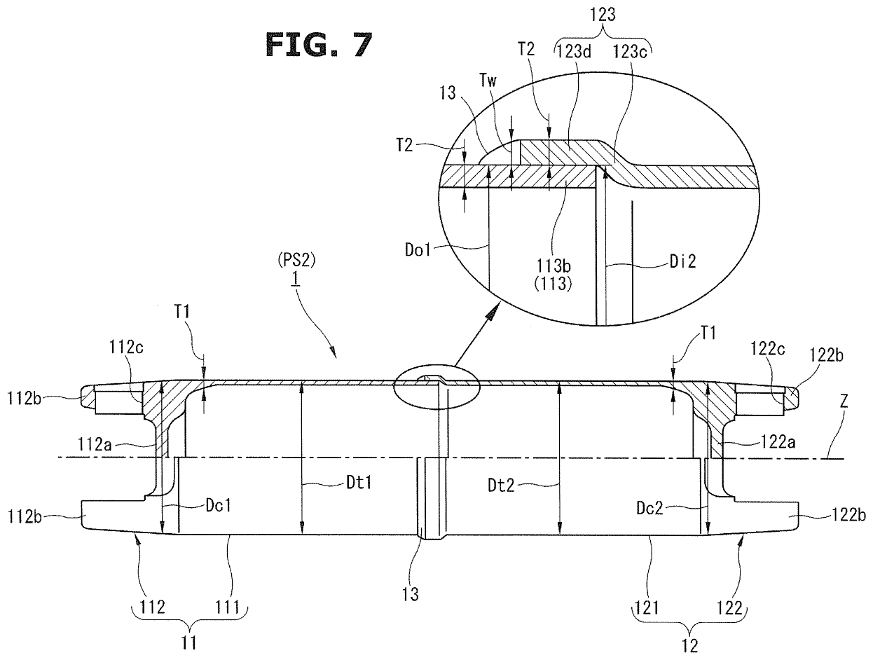

FIG. 7 is a second embodiment of the propeller shaft according to the present invention, and illustrates a modified configuration of the welding portion 13 of the first embodiment. Since a basic configuration except modified points is the same as that of the first embodiment, the same structure or configuration as that of the first embodiment is denoted by the same reference sign, and its detailed description is omitted here.

FIG. 7 is a cross section of a propeller shaft PS2 according to the second embodiment of the present invention, illustrated by cutting the shaft body 1 along an axial direction of the propeller shaft PS2.

As illustrated in FIG. 7, as in the first embodiment, the propeller shaft PS2 according to the present embodiment has the first tubular member 11 and the second tubular member 12, and the first opening end portion 113 and the second opening end portion 123 are connected through the welding portion 13 formed by the laser-welding with the phase in the rotation direction of the first joint yoke portions 112b, 112b of the first joint portion 112 and the phase in the rotation direction of the second joint yoke portions 122b, 122b of the second joint portion 122 coinciding with each other. Then, in this propeller shaft PS2, at the second opening end portion 123 of the second tubular portion 121, a second end portion of the second tubular portion 121 is widened stepwise in diameter so that an inside diameter Di2 of the second end portion of the second tubular portion 121 is equal to an outside diameter Do1 of a second end portion of the first tubular portion 111, and the second end portion of the second tubular portion 121 can be fitted onto an outer side of the first opening end portion 113.

More specifically, the second opening end portion 123 of the second tubular portion 121 has an outer step portion 123c that is bent or curved stepwise outwards in the radial direction and a widened diameter portion 123d that is widened in diameter from the outer step portion 123c and extends along the axial direction. Then, the second opening end portion 123 is connected to the first opening end portion 113 with the outer step portion 123c facing the first opening end portion 113 in the axial direction and with the widened diameter portion 123d fitted onto an outer circumferential side of the first opening end portion 113. In other words, in a relationship with the second opening end portion 123, the first opening end portion 113 forms an enclosed portion 113b that is covered with an inner circumferential side of the widened diameter portion 123d of the second opening end portion 123.

As described above, the second tubular member 12 has the same shape as that of the first tubular member 11 except for the second opening end portion 123. In other words, the second tubular member 12 is a member formed by adding the outer step portion 123c and the widened diameter portion 123d to the first opening end portion 113 of the first tubular member 11.

The welding portion 13 is formed throughout the entire circumference of the tubular member along the circumferential direction while straddling the first opening end portion 113 of the first tubular portion 111 and the outer step portion 123c of the second tubular portion 121. That is, this welding portion 13 is formed so as to bulge in a padded manner (or in a build-up manner) between the first opening end portion 113 of the first tubular portion 111 and the outer step portion 123c of the second tubular portion 121. In other words, the welding portion 13 has a substantially arc-shaped cross section that bulges outwards in the radial direction, and has a diameter Dw that is larger than the diameter Dt1 of the first tubular portion 111, the diameter Dc1 of the first joint portion 112, a diameter Dt2 of the second tubular portion 121 and a diameter Dc2 of the second joint portion 122. Further, a thickness Tw of the welding portion 13 is formed so as to be thinner than the thickness T1 of the first end portion of the first tubular portion 111 and also thinner than the thickness T1 of the first end portion of the second tubular portion 121.

As described above, in the manufacturing method of the propeller shaft PS2 according to the present embodiment, at the second step, between the second joint portion 122 and the second opening end portion 123 of the second tubular member 12, the widened diameter portion 123d whose diameter is widened stepwise from the second joint portion 122 toward the second opening end portion 123 is formed. Further, at the third step, the laser-welding is performed with the widened diameter portion 123d being fitted onto the outer circumferential side of the first opening end portion 113 (the enclosed portion 113b).

In other words, in the propeller shaft PS2 according to the present embodiment, the second tubular portion 121 has, between the welding portion 13 and the second opening end portion 123, the widened diameter portion 123d whose diameter is widened stepwise from the second joint portion 122 toward the second opening end portion 123. Also, the first tubular portion 111 has, between the first joint portion 112 and the first opening end portion 113, the enclosed portion 113b that is covered with the inner circumferential side of the widened diameter portion 123d.

As described above, according to the present embodiment, since the laser-welding is performed with the widened diameter portion 123d of the second tubular member 12 being fitted onto the outer circumferential side of the first opening end portion 113 (the enclosed portion 113b) of the first tubular member 11, misalignment between the first tubular member 11 and the second tubular member 12 can be suppressed. The imbalance in rotation of the propeller shaft PS2 can therefore be suppressed.

### First Modified Example

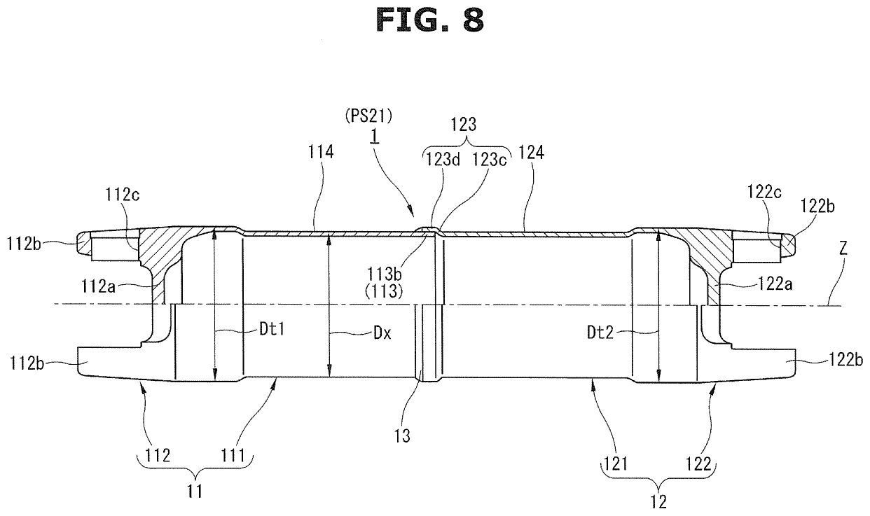

FIG. 8 is a first modified example of the second embodiment of the propeller shaft according to the present invention, and illustrates a modified configuration of the shaft body 1 of the second embodiment. Since a basic configuration except modified points is the same as that of the second embodiment, the same structure or configuration as that of the second embodiment is denoted by the same reference sign, and its detailed description is omitted here.

FIG. 8 is a cross section of a propeller shaft PS21 according to the first modified example of the second embodiment of the present invention, illustrated by cutting the shaft body 1 along an axial direction of the propeller shaft PS21.

As illustrated in FIG. 8, the propeller shaft PS21 according to the present modified example is formed so that a middle portion in the axial direction of the shaft body 1 is reduced in diameter and an outside diameter Dx of the middle portion in the axial direction of the shaft body 1 is smaller than outside diameters Dt1 and Dt2 of both end portions (a first end portion of the first tubular portion 111 and a first end portion of the second tubular portion 121) in the axial direction of the shaft body 1. In other words, the propeller shaft PS21 is the same as that of the second embodiment, except that the axial direction middle portion of the shaft body 1 is reduced in diameter.

More specifically, the propeller shaft PS21 has, between the first joint portion 112 and the first opening end portion 113 of the first tubular member 11, a first reduced diameter portion 114 whose outside diameter is reduced stepwise from the first joint portion 112 toward the first opening end portion 113. Likewise, the propeller shaft PS21 also has, between the second joint portion 122 and the second opening end portion 123 of the second tubular member 12, a second reduced diameter portion 124 whose outside diameter is reduced stepwise from the second joint portion 122 toward the second opening end portion 123. Then, an outer step portion 123c and a widened diameter portion 123d that are widened stepwise in diameter in the radially outward direction are formed at the second opening end portion 123 of the second reduced diameter portion 124.

In this manner, the propeller shaft PS21 according to the present modified example is formed by laser-welding a portion (or a space) between a tip edge of the widened diameter portion 123d of the second opening end portion 123 and an outer circumferential surface of the first opening end portion 113 along the circumferential direction with the widened diameter portion 123d provided at the second opening end portion 123 of the second reduced diameter portion 124 being press-fitted onto an outer circumferential side of the first opening end portion 113 of the first reduced diameter portion 114.

As described above, also in the present modified example, since the axial direction middle portion of the shaft body 1 is formed into the reduced diameter shape by the first reduced diameter portion 114 and the second reduced diameter portion 124, increase in weight of the shaft body 1 can be suppressed, thereby reducing weight of the propeller shaft PS21.

Further, also in the present modified example, since the axial direction middle portion of the shaft body 1 is formed into the reduced diameter shape by the first reduced diameter portion 114 and the second reduced diameter portion 124, it becomes possible to lay out the propeller shaft PS21 even in a vehicle having a narrow mounting space, thereby having the merit of improving layout property of the propeller shaft PS21.

### Second Modified Example

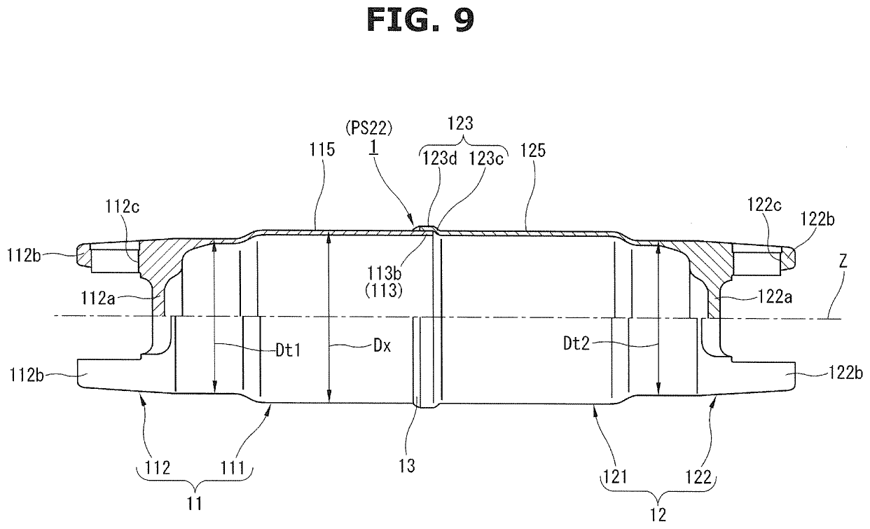

FIG. 9 is a second modified example of the second embodiment of the propeller shaft according to the present invention, and illustrates a modified configuration of the shaft body 1 of the second embodiment. Since a basic configuration except modified points is the same as that of the second embodiment, the same structure or configuration as that of the second embodiment is denoted by the same reference sign, and its detailed description is omitted here.

FIG. 9 is a cross section of a propeller shaft PS22 according to the second modified example of the second embodiment of the present invention, illustrated by cutting the shaft body 1 along an axial direction of the propeller shaft PS22.

As illustrated in FIG. 9, the propeller shaft PS22 according to the present modified example is formed so that a middle portion in the axial direction of the shaft body 1 is widened in diameter and an outside diameter Dx of the middle portion in the axial direction of the shaft body 1 is larger than outside diameters Dt1 and Dt2 of both end portions (a first end portion of the first tubular portion 111 and a first end portion of the second tubular portion 121) in the axial direction of the shaft body 1. In other words, the propeller shaft PS22 is the same as that of the second embodiment, except that the axial direction middle portion of the shaft body 1 is widened in diameter.

More specifically, the propeller shaft PS22 has, between the first joint portion 112 and the first opening end portion 113 of the first tubular member 11, a first widened diameter portion 115 whose outside diameter is widened stepwise from the first joint portion 112 toward the first opening end portion 113. Likewise, the propeller shaft PS22 also has, between the second joint portion 122 and the second opening end portion 123 of the second tubular member 12, a second widened diameter portion 125 whose outside diameter is widened stepwise from the second joint portion 122 toward the second opening end portion 123. Then, an outer step portion 123c and a widened diameter portion 123d that are further widened stepwise in diameter in the radially outward direction are formed at the second opening end portion 123 of the second widened diameter portion 125.

In this manner, the propeller shaft PS22 according to the present modified example is formed by laser-welding a portion (or a space) between a tip edge of the widened diameter portion 123d of the second opening end portion 123 and an outer circumferential surface of the first opening end portion 113 along the circumferential direction with the widened diameter portion 123d provided at the second opening end portion 123 of the second widened diameter portion 125 being press-fitted onto an outer circumferential side of the first opening end portion 113 of the first widened diameter portion 115.

As described above, also in the present modified example, since the axial direction middle portion of the shaft body 1 is formed into the widened diameter shape by the first widened diameter portion 115 and the second widened diameter portion 125, strength of the propeller shaft PS22 can be increased.

Further, also in the present modified example, since the axial direction middle portion of the shaft body 1 is formed into the widened diameter shape by the first widened diameter portion 115 and the second widened diameter portion 125, it is possible to improve a bending characteristic value of the propeller shaft PS22.

### Third Embodiment

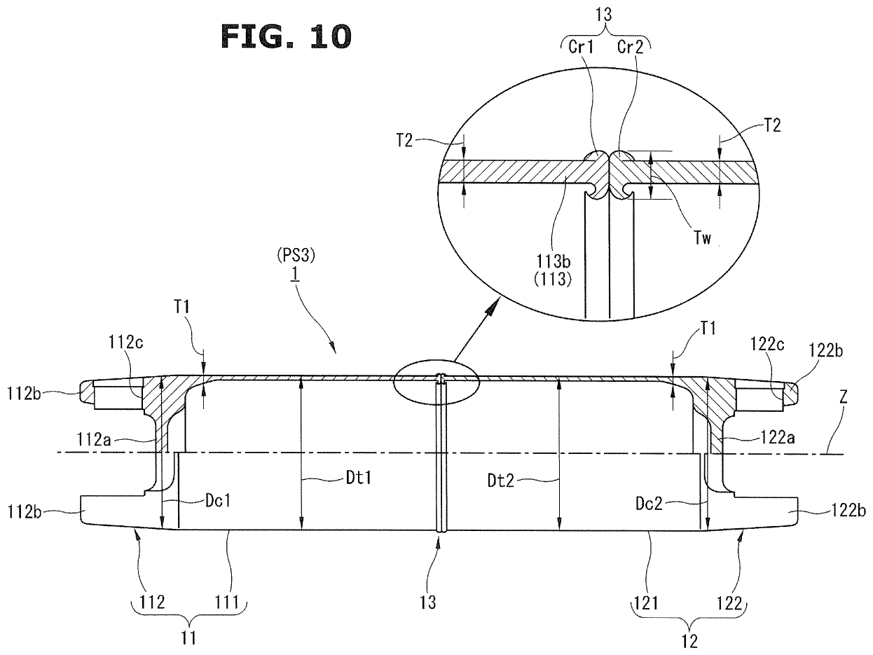

FIG. 10 is a third embodiment of the propeller shaft according to the present invention, and illustrates a modified configuration of the welding portion 13 of the first embodiment. Since a basic configuration except modified points is the same as that of the first embodiment, the same structure or configuration as that of the first embodiment is denoted by the same reference sign, and its detailed description is omitted here.

FIG. 10 is a cross section of a propeller shaft PS3 according to the third embodiment of the present invention, illustrated by cutting the shaft body 1 along an axial direction of the propeller shaft PS3.

As illustrated in FIG. 10, in the propeller shaft PS3 according to the present embodiment, the first tubular member 11 and the second tubular member 12 which have the same shape are connected by friction welding. That is, in the propeller shaft PS3, the first opening end portion 113 of the first tubular member 11 and the second opening end portion 123 of the second tubular member 12 are connected through the welding portion 13 formed by the friction welding with the phase in the rotation direction of the first joint yoke portions 112b, 112b of the first joint portion 112 and the phase in the rotation direction of the second joint yoke portions 122b, 122b of the second joint portion 122 coinciding with each other.

The welding portion 13 is provided at a middle portion of the shaft body 1, and is formed throughout the entire circumference of the tubular member along the circumferential direction. More specifically, the welding portion 13 has a first curl portion Cr1 formed at an inner circumferential side and an outer circumferential side of the first opening end portion 113 by the friction welding and a second curl portion Cr2 formed at an inner circumferential side and an outer circumferential side of the second opening end portion 123 by the friction welding. Further, the welding portion 13 has a diameter Dw that is larger than the diameter Dt1 of the first tubular portion 111, the diameter Dc1 of the first joint portion 112, a diameter Dt2 of the second tubular portion 121 and a diameter Dc2 of the second joint portion 122. In addition, a thickness Tw of the welding portion 13 is formed so as to be thinner than the thickness T1 of the first end portion of the first tubular portion 111 and also thinner than the thickness T1 of the first end portion of the second tubular portion 121.

As described above, in the manufacturing method of the propeller shaft PS3 according to the present embodiment, the welding portion 13 is formed by the friction welding.

As described above, according to the present embodiment, by forming the welding portion 13 by the friction welding, unlike the case of the laser-welding, there is no need to overlap the first opening end portion 113 and the second opening end portion 123 at the welding portion 13. Therefore, the welding portion 13 can be formed thinnest, then the welding portion 13 can be made lightest. It is thus possible to suppress the runout (or run-out) and the imbalance in rotation of the propeller shaft PS3 most effectively during rotation of the propeller shaft PS3.

Further, in the propeller shaft PS3 according to the present embodiment, the welding portion 13 is formed at the middle portion in the direction of the rotation axis Z of the tubular member (the shaft body 1).

As described above, in the present embodiment, since the welding portion 13 is disposed at the middle portion of the shaft body 1, the first tubular member 11 and the second tubular member 12 can be used as a common member. It is therefore possible to reduce the number of management points of the components of the shaft body 1, thereby lowering manufacturing cost of the propeller shaft PS3.

Moreover, in the propeller shaft PS3 according to the present embodiment, the welding portion 13 has the curl portions (the first curl portion Cr1 and the second curl portion Cr2) at the inner circumferential side and the outer circumferential side of the tubular member (the shaft body 1).

As described above, in the present embodiment, the first tubular portion 111 and the second tubular portion 121 are welded by the friction welding with the first curl portion Cr1 and the second curl portion Cr2 being formed at the welding portion 13. Therefore, unlike the case of the laser-welding, there is no need to overlap the first opening end portion 113 and the second opening end portion 123 at the welding portion 13. It is thus possible to form the first opening end portion 113 and the second opening end portion 123 into the same shape, thereby lowering manufacturing cost of the propeller shaft PS3.

Further, since the first tubular portion 111 and the second tubular portion 121 are welded by the friction welding, it is possible to form the thickness of the first tubular portion 111 and the thickness of the second tubular portion 121 to be the same. Therefore, weight of the welding portion 13 can be suppressed to the minimum. In addition to reduction in weight of the propeller shaft PS3, imbalance in rotation of the welding portion 13 can be suppressed to the minimum, thereby improving vibration performance of the propeller shaft PS3.

### First Modified Example

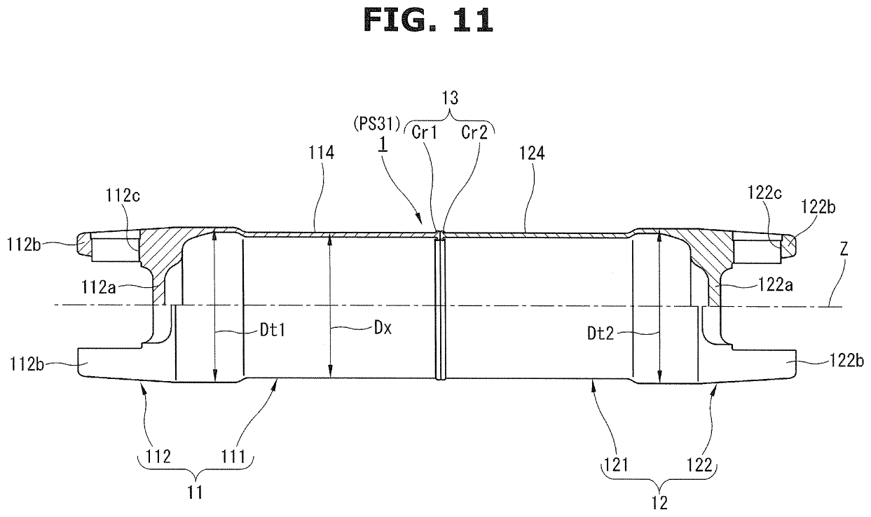

FIG. 11 is a first modified example of the third embodiment of the propeller shaft according to the present invention, and illustrates a modified configuration of the shaft body 1 of the third embodiment. Since a basic configuration except modified points is the same as that of the third embodiment, the same structure or configuration as that of the third embodiment is denoted by the same reference sign, and its detailed description is omitted here.

FIG. 11 is a cross section of a propeller shaft PS31 according to the first modified example of the third embodiment of the present invention, illustrated by cutting the shaft body 1 along an axial direction of the propeller shaft PS31.

As illustrated in FIG. 11, the propeller shaft PS31 according to the present modified example is formed so that a middle portion in the axial direction of the shaft body 1 is reduced in diameter and an outside diameter Dx of the middle portion in the axial direction of the shaft body 1 is smaller than outside diameters Dt1 and Dt2 of both end portions (a first end portion of the first tubular portion 111 and a first end portion of the second tubular portion 121) in the axial direction of the shaft body 1. In other words, the propeller shaft PS31 is the same as that of the third embodiment, except that the axial direction middle portion of the shaft body 1 is reduced in diameter.

More specifically, the propeller shaft PS31 has, between the first joint portion 112 and the first opening end portion 113 of the first tubular member 11, a first reduced diameter portion 114 whose outside diameter is reduced stepwise from the first joint portion 112 toward the first opening end portion 113. Likewise, the propeller shaft PS31 also has, between the second joint portion 122 and the second opening end portion 123 of the second tubular member 12, a second reduced diameter portion 124 whose outside diameter is reduced stepwise from the second joint portion 122 toward the second opening end portion 123.

Then, in the propeller shaft PS31 according to the present modified example, the first opening end portion 113 of the first reduced diameter portion 114 and the second opening end portion 123 of the second reduced diameter portion 124 are welded by the friction welding. That is, in the propeller shaft PS31, the first opening end portion 113 of the first reduced diameter portion 114 and the second opening end portion 123 of the second reduced diameter portion 124 are connected through the welding portion 13 formed from the first curl portion Cr1 and the second curl portion Cr2 by the friction welding.

As described above, also in the present modified example, since the axial direction middle portion of the shaft body 1 is formed into the reduced diameter shape by the first reduced diameter portion 114 and the second reduced diameter portion 124, increase in weight of the shaft body 1 can be suppressed, thereby reducing weight of the propeller shaft PS31.

Further, also in the present modified example, since the axial direction middle portion of the shaft body 1 is formed into the reduced diameter shape by the first reduced diameter portion 114 and the second reduced diameter portion 124, it becomes possible to lay out the propeller shaft PS21 even in a vehicle having a narrow mounting space, thereby having the merit of improving layout property of the propeller shaft PS31.

### Second Modified Example

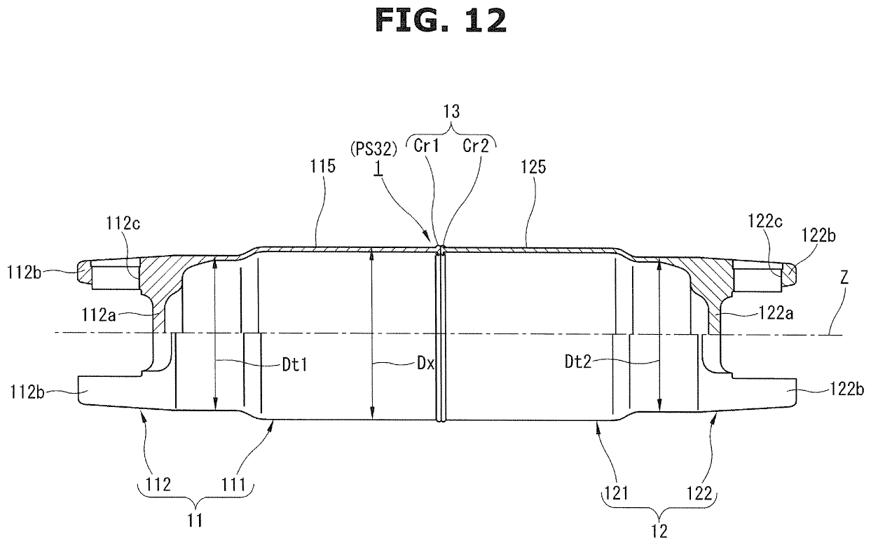

FIG. 12 is a second modified example of the third embodiment of the propeller shaft according to the present invention, and illustrates a modified configuration of the shaft body 1 of the third embodiment. Since a basic configuration except modified points is the same as that of the third embodiment, the same structure or configuration as that of the third embodiment is denoted by the same reference sign, and its detailed description is omitted here.

FIG. 12 is a cross section of a propeller shaft PS32 according to the second modified example of the third embodiment of the present invention, illustrated by cutting the shaft body 1 along an axial direction of the propeller shaft PS32.

As illustrated in FIG. 12, the propeller shaft PS32 according to the present modified example is formed so that a middle portion in the axial direction of the shaft body 1 is widened in diameter and an outside diameter Dx of the middle portion in the axial direction of the shaft body 1 is larger than outside diameters Dt1 and Dt2 of both end portions (a first end portion of the first tubular portion 111 and a first end portion of the second tubular portion 121) in the axial direction of the shaft body 1. In other words, the propeller shaft PS32 is the same as that of the third embodiment, except that the axial direction middle portion of the shaft body 1 is widened in diameter.

More specifically, the propeller shaft PS32 has, between the first joint portion 112 and the first opening end portion 113 of the first tubular member 11, a first widened diameter portion 115 whose outside diameter is widened stepwise from the first joint portion 112 toward the first opening end portion 113. Likewise, the propeller shaft PS32 also has, between the second joint portion 122 and the second opening end portion 123 of the second tubular member 12, a second widened diameter portion 125 whose outside diameter is widened stepwise from the second joint portion 122 toward the second opening end portion 123.

Then, in the propeller shaft PS32 according to the present modified example, the first opening end portion 113 of the first widened diameter portion 115 and the second opening end portion 123 of the second widened diameter portion 125 are welded by the friction welding. That is, in the propeller shaft PS31, the first opening end portion 113 of the first widened diameter portion 115 and the second opening end portion 123 of the second widened diameter portion 125 are connected through the welding portion 13 formed from the first curl portion Cr1 and the second curl portion Cr2 by the friction welding.

As described above, also in the present modified example, since the axial direction middle portion of the shaft body 1 is formed into the widened diameter shape by the first widened diameter portion 115 and the second widened diameter portion 125, strength of the propeller shaft PS32 can be increased.

Further, also in the present modified example, since the axial direction middle portion of the shaft body 1 is formed into the widened diameter shape by the first widened diameter portion 115 and the second widened diameter portion 125, it is possible to improve a bending characteristic value of the propeller shaft PS32.

The present invention is not limited to the configurations or structures exemplified in the above embodiments. As long as above-described working and effect of the present invention can be obtained, the present invention can be freely changed according to specification, cost etc. of objects to which the present invention is applied.

1. A method of manufacturing a propeller shaft transmitting a driving force of a vehicle comprising:
a first step of forming, by plastic working of metal material, a first tubular member having a first tubular portion and a first joint portion seamlessly integrated with the first tubular portion at a first end portion in a direction of a rotation axis of the first tubular portion;
a second step of forming, by plastic working of metal material, a second tubular member having a second tubular portion and a second joint portion seamlessly integrated with the second tubular portion at a first end portion in a direction of a rotation axis of the second tubular portion; and
a third step of welding a first opening end portion formed at a second end portion located on an opposite side to the first end portion of the first tubular portion so as to be thinner than a thickness of the first end portion of the first tubular portion and a second opening end portion formed at a second end portion located on an opposite side to the first end portion of the second tubular portion so as to be thinner than a thickness of the first end portion of the second tubular portion, and of forming a welding portion whose thickness is thinner than the thickness of the first end portion of the first tubular portion and also thinner than the thickness of the first end portion of the second tubular portion.

2. The method of manufacturing the propeller shaft as claimed in claim 1, wherein
the plastic workings at the first step and the second step are performed by impact extrusion.

3. The method of manufacturing the propeller shaft as claimed in claim 2, wherein
each of the first joint portion and the second joint portion is formed into a bifurcated yoke shape.

4. The method of manufacturing the propeller shaft as claimed in claim 3, wherein
a phase in a rotation direction of a bifurcated yoke of the first joint portion and a phase in a rotation direction of a bifurcated yoke of the second joint portion coincide with each other.

5. The method of manufacturing the propeller shaft as claimed in claim 1, wherein
the welding portion is formed by friction welding.

6. The method of manufacturing the propeller shaft as claimed in claim 1, wherein
the welding portion is formed by laser-welding.

7. The method of manufacturing the propeller shaft as claimed in claim 6, wherein
at the second step, between the second joint portion and the second opening end portion of the second tubular member, a reduced diameter portion that is reduced stepwise in diameter from the second joint portion toward the second opening end portion is formed, and
at the third step, the laser-welding is performed with the reduced diameter portion being fitted into an inner circumferential side of the first opening end portion.

8. The method of manufacturing the propeller shaft as claimed in claim 6, wherein
at the second step, between the second joint portion and the second opening end portion of the second tubular member, a widened diameter portion whose diameter is widened stepwise from the second joint portion toward the second opening end portion is formed, and
at the third step, the laser-welding is performed with the widened diameter portion being fitted onto an outer circumferential side of the first opening end portion.

9. The method of manufacturing the propeller shaft as claimed in claim 1, wherein
at the first step, between the first joint portion and the first opening end portion of the first tubular member, a first reduced diameter portion whose outside diameter is reduced from the first joint portion toward the first opening end portion is formed,
at the second step, between the second joint portion and the second opening end portion of the second tubular member, a second reduced diameter portion whose outside diameter is reduced from the second joint portion toward the second opening end portion is formed, and
at the third step, the first reduced diameter portion and the second reduced diameter portion are welded.

10. The method of manufacturing the propeller shaft as claimed in claim 1, wherein
at the first step, between the first joint portion and the first opening end portion of the first tubular member, a first widened diameter portion whose outside diameter is widened from the first joint portion toward the first opening end portion is formed,
at the second step, between the second joint portion and the second opening end portion of the second tubular member, a second widened diameter portion whose outside diameter is widened from the second joint portion toward the second opening end portion is formed, and
at the third step, the first widened diameter portion and the second widened diameter portion are welded.

11. A propeller shaft transmitting a driving force of a vehicle comprising:
a tubular member formed by connecting a first tubular portion and a second tubular portion;
a first joint portion provided at a first end portion in a direction of a rotation axis of the first tubular portion and seamlessly integrated with the first tubular portion;
a second joint portion provided at a first end portion in a direction of a rotation axis of the second tubular portion and seamlessly integrated with the second tubular portion; and
a welding portion where a first opening end portion provided at a second end portion located on an opposite side to the first end portion of the first tubular portion and formed so as to be thinner than a thickness of the first end portion of the first tubular portion and a second opening end portion provided at a second end portion located on the opposite side to the first end portion of the second tubular portion and formed so as to be thinner than a thickness of the first end portion of the second tubular portion are welded to each other, the welding portion having a thickness that is thinner than the thickness of the first end portion of the first tubular portion and also thinner than the thickness of the first end portion of the second tubular portion.

12. The propeller shaft as claimed in claim 11, wherein
at least one of a set of the first tubular portion and the first joint portion and a set of the second tubular portion and the second joint portion is formed by impact extrusion.

13. The propeller shaft as claimed in claim 11, wherein
the welding portion is formed at a middle portion in a direction of a rotation axis of the tubular member.

14. The propeller shaft as claimed in claim 11, wherein
the welding portion has curl portions at an inner circumferential side and an outer circumferential side of the tubular member.

15. The propeller shaft as claimed in claim 11, wherein
the second tubular portion has, between the welding portion and the second opening end portion, a reduced diameter portion that is reduced stepwise in diameter from the welding portion toward the second opening end portion, and
the first tubular portion has, between the first joint portion and the first opening end portion, an enclosing portion that covers an outer circumferential side of the reduced diameter portion.

16. The propeller shaft as claimed in claim 11, wherein
the second tubular portion has, between the welding portion and the second opening end portion, a widened diameter portion whose diameter is widened stepwise from the second joint portion toward the second opening end portion, and
the first tubular portion has, between the first joint portion and the first opening end portion, an enclosed portion that is covered with an inner circumferential side of the widened diameter portion.

17. The propeller shaft as claimed in claim 11, wherein
the first tubular portion has, between the first joint portion and the first opening end portion, a first reduced diameter portion whose outside diameter is reduced from the first joint portion toward the first opening end portion,
the second tubular portion has, between the second joint portion and the second opening end portion, a second reduced diameter portion whose outside diameter is reduced from the second joint portion toward the second opening end portion, and
as the welding portion, the first reduced diameter portion and the second reduced diameter portion are welded.

18. The propeller shaft as claimed in claim 11, wherein
the first tubular portion has, between the first joint portion and the first opening end portion, a first widened diameter portion whose outside diameter is widened from the first joint portion toward the first opening end portion,
the second tubular portion has, between the second joint portion and the second opening end portion, a second widened diameter portion whose outside diameter is widened from the second joint portion toward the second opening end portion, and
as the welding portion, the first widened diameter portion and the second widened diameter portion are welded.

19. The propeller shaft as claimed in claim 11, wherein
the tubular member is made of metal material containing aluminium.

20. The propeller shaft as claimed in claim 11, wherein
a diameter of the welding portion is largest as compared with diameters of the first tubular portion, the first joint portion, the second tubular portion and the second joint portion.
